(19) United States
(12) Patent Application Publication
(10) Pub. No.: US 2025/0385506 A1
(43) Pub. Date: Dec. 18, 2025

(54) MANAGING LEAKAGE CURRENT IN SOLID-STATE CIRCUIT BREAKERS WITH MULTIPLE LOAD-TO-LINE CONNECTIONS SWITCHED WITH MICROCONTROLLER UNITS

(71) Applicant: Rockwell Automation Technologies, Inc., Mayfield Heights, OH (US)

(72) Inventors: Andrew E. Carlson, Franklin, WI (US); David Elmiger, Hitzkirch (CH); Kyle B. Adkins, Oak Creek, WI (US); James E. Brickner, Wauwatosa, WI (US); Randall S. Langer, Oak Creek, WI (US); Robert D. Bates, Franklin, WI (US); Yutao Wang, Brookfield, WI (US)

(21) Appl. No.: 19/303,003

(22) Filed: Aug. 18, 2025

Related U.S. Application Data
(63) Continuation of application No. 19/080,440, filed on Mar. 14, 2025.
(60) Provisional application No. 63/565,723, filed on Mar. 15, 2024.

(51) Int. Cl. H02H 1/04; H02H 3/08

(52) U.S. Cl. CPC H02H 1/04; H02H 3/083

(57) ABSTRACT

Various embodiments relate to reducing leakage current produced by solid-state switching devices of circuit breakers. A circuit breaker may include processing circuitry and switching circuitry coupled to the processing circuitry, to an AC voltage supply having three phase terminals, and to a load having three phase terminals. The switching circuitry includes three phase circuits each coupled to a phase terminal of the AC voltage supply and to a phase terminal of the load. Each phase circuit includes a first switch, a second switch, and two leakage current circuits. Each of the two leakage current circuits is coupled to a different one of two other phase terminals of the AC voltage supply. The processing circuitry controls current flow through the switching circuitry by providing gating signals to the two leakage current circuits of each phase circuit based on voltage potentials of the circuit breaker and a mode of the switching circuitry.

### RELATED APPLICATIONS

This application is a continuation of and claims priority to U.S. patent application Ser. No. 19/080,440, titled “MANAGING LEAKAGE CURRENT IN SOLID-STATE CIRCUIT BREAKERS WITH MULTIPLE LOAD-TO-LINE CONNECTIONS,” filed Mar. 14, 2025, which claims priority to U.S. Patent Application No. 63/565,723, titled “LIMITING LEAKAGE CURRENT IN SOLID STATE CIRCUIT BREAKERS,” filed Mar. 15, 2024, both of which are hereby incorporated by reference in their entirety.

### TECHNICAL FIELD

Various embodiments of the present technology relate to circuit breakers, and particularly to leakage current reduction in circuit breakers in an industrial automation environment.

### BACKGROUND

Circuit breakers are electrical switching devices designed to protect electrical circuits from potential damage that can be caused by short circuits or overloads. Circuit breakers are implemented in industrial environments as components of electrical circuits to allow current flow through the circuit in one mode and prevent current flow through the circuit in another mode. An example type of circuit breaker is a solid-state circuit breaker. Solid-state circuit breakers may include both physical switches (e.g., mechanical contacts) and solid-state switching devices (e.g., transistors) to transition between modes. More specifically, in an on mode, an electrical connection is created by closing switches of the circuit breaker. In an off mode, the switches are opened to interrupt the current flow in the circuit. The mode transitions may occur manually or automatically to switch the circuit breaker on and off.

Solid-state circuit breakers may also operate in a standby mode. When in the standby mode, the mechanical contacts are closed, and the solid-state switching devices are open/off. In this way, the circuit breaker is powered on and operates in a high-impedance mode to allow for fault detection and condition sensing while still interrupting current flow in the circuit. Despite preventing current flow in the circuit, the solid-state switching devices may leak current when off. These leakage currents may be attributed to intrinsic semiconductor design.

Problematically, even small amounts of leakage current can create a shock hazard to humans, charge certain loads that could build hazardous energy unintentionally, and cause other issues. To avoid such problems, some circuit breakers include high quality switching devices to reduce leakage currents or additional mechanical components to increase isolation. However, such solutions may be costly.

It is with respect to this general technical environment that aspects of the present disclosure have been contemplated. Furthermore, although a general environment is discussed, it should be understood that the examples described should not be limited to the general environment identified in the background.

### SUMMARY

Various embodiments of the present technology generally relate to improvements to industrial circuit breakers. More specifically, systems, devices, and methods are disclosed for reducing leakage currents within a circuit breaker by routing leakage currents from load terminals to voltage supply terminals. In an embodiment of the present technology, a circuit breaker is provided. The circuit breaker includes processing circuitry and switching circuitry coupled to the processing circuitry, to an alternating current (AC) voltage supply, and to a load. The switching circuitry includes a first-phase circuit, a second-phase circuit, and a third-phase circuit, each of the first-phase, second-phase, and third-phase circuits including a first switch including a first terminal coupled to a respective phase terminal of the load, and a second terminal, a second switch including a first terminal coupled to the second terminal of the first switch, and a second terminal coupled to a respective phase terminal of the AC voltage supply, and two leakage current circuits, each including a first terminal coupled to the second terminal of the first switch and a second terminal, wherein the second terminal of each of the two leakage current circuits is coupled to a different one of the two other phase terminals of the AC voltage supply. The processing circuitry controls current flow through the switching circuitry at least in part by providing gating signals to the two leakage current circuits of each of the first-phase, second-phase, and third-phase circuits based at least in part on voltage potentials between the phase terminals of the AC voltage supply and the phase terminals of the load and a mode of the switching circuitry.

In another example embodiment, a method is provided that includes monitoring voltage potentials in a circuit breaker and controlling current flow in the circuit breaker based on the voltage potentials. The circuit breaker includes switching circuitry coupled between an AC voltage supply and a load. The switching circuitry includes three phase circuits, each of the phase circuits including a disconnect switch, a current-control switch, two leakage current circuits. Each of the two leakage current circuits is coupled between a load side of the current-control switch of a respective phase circuit and to a line side of the current-control switch of a different one of the phase circuits. The method includes, for each of the phase circuits, responsive to determining a voltage potential between the load side of the current-control switch of the respective phase circuit and a line side of the current-control switch of at least one of the different ones of the phase circuits reaching a threshold voltage level, transmitting signals to one or more of the two leakage current circuits of the respective phase circuit, allowing leakage current flow from the load side of the current-control switch of the respective phase circuit to the line side of the current-control switch of the at least one of the different ones of the phase circuits.

In yet another example embodiment, one or more non-transitory computer-readable storage media having stored thereon program instructions executable by processing circuitry of a circuit breaker, that, when executed by one or more processors, direct the processing circuitry to perform various functions. The circuit breaker includes switching circuitry coupled between an AC voltage supply and a load. The switching circuitry includes three phase circuits, each of the phase circuits including a disconnect switch, a current-control switch, two leakage current circuits. Each of the two leakage current circuits is coupled between a load side of the current-control switch of a respective phase circuit and to a line side of the current-control switch of a different one of the phase circuits. In operation, the program instructions direct the processing circuitry to monitor voltage potentials in the circuit breaker, and for each of the phase circuits, responsive to determining a voltage potential between the load side of the current-control switch of the respective phase circuit and a line side of the current-control switch of at least one of the different ones of the phase circuits reaching a threshold voltage level, transmit signals to one or more of the two leakage current circuits of the respective phase circuit, allowing leakage current flow from the load side of the current-control switch of the respective phase circuit to the line side of the current-control switch of the at least one of the different ones of the phase circuits.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

While multiple embodiments are disclosed, still other embodiments of the present technology will become apparent to those skilled in the art from the following detailed description, which shows and describes illustrative embodiments of the invention. As will be realized, the technology is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example operating environment in accordance with some embodiments of the present technology.

FIG. 2 illustrates an example operating environment in accordance with some embodiments of the present technology.

FIG. 3 illustrates an example operating environment in accordance with some embodiments of the present technology.

FIG. 4 illustrates example graphical representations of current flow through elements of a circuit breaker in accordance with some embodiments of the present technology.

FIG. 5 illustrates a series of steps for routing leakage current flow within a circuit breaker in accordance with some embodiments of the present technology.

FIG. 6 illustrates an example computing system used in some embodiments of the present technology.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Technology is disclosed herein that mitigates the problems discussed above with respect to industrial circuit breakers and associated leakage current while operating a circuit breaker in a standby mode. A circuit breaker is a switching device that interrupts current flow during fault conditions or overload situations, thereby preventing damage caused by overcurrent. In industrial or commercial environments, circuit breakers are used to protect various electrical systems and devices while the systems and devices perform industrial automation operations. For example, a circuit breaker may be included in a circuit of a system powered by an alternating current (AC) power source (e.g., AC mains). The recipient of the AC power is referred to as the load. In operation, the circuit breaker can be turned on to allow current flow from the AC power source through the circuit breaker and through the system to allow the system to perform respective functions. The circuit breaker can also be turned off to prevent current flow and protect the system from potential damage that can be caused by short circuits or overloads.

Some circuit breakers, such as electromechanical circuit breakers, include numerous mechanical components and physical contacts that move and shift positions to allow current flow (i.e., turn on) and prevent current flow (i.e., turn off). Some circuit breakers, such as solid-state circuit breakers, additionally or alternatively include solid-state switching components (e.g., transistors) to allow current flow and prevent current flow.

Solid-state circuit breakers offer more robust and cheaper solutions than electromechanical circuit breakers, but they have drawbacks. For example, solid-state circuit breakers include switching components that may leak undesired amounts of current that can damage a load coupled to the circuit breaker. While in an on mode, a mechanical switch of the solid-state circuit breaker is closed, and solid-state switching components are turned on (i.e., operated as closed switches via signals provided to control terminals of the solid-state switching components) thereby allowing current flow from the AC power source to the load. In an off mode, the mechanical switch is open thereby disconnecting the AC power source from the load and preventing current flow through the circuit breaker.

Solid-state circuit breakers can also operate in a standby mode in which current flow remains prevented, but current and voltage sensing can be performed to monitor for potential safety issues. In the standby mode, the mechanical switch is closed while the solid-state switching components are turned off (i.e., operated as open switches via signals provided to control terminals of the solid-state switching components). Problematically, as mentioned above, while the solid-state switching components prevent current flow from the AC power source to the load, the solid-state switching components themselves may leak current (referred to as leakage current) to the load, which may damage the load, create a risk to humans, and cause other issues. These solid-state switching components produce leakage current naturally based on their inherent design. While high-quality materials may reduce the amount of leakage current, such components are costly.

To address these issues, a circuit breaker is described herein that includes multiple leakage current circuits for reducing an amount of leakage current flowing through the circuit breaker to a load coupled to the circuit breaker. More specifically, the circuit breaker includes three sub-circuits each corresponding to a phase of three-phase AC power supplied to the circuit breaker by an AC power source. Each sub-circuit is coupled to one phase terminal of the AC power source and to a respective phase terminal of the load. Each sub-circuit includes one leakage current circuit coupled to one other phase terminal of the AC power source, and another leakage current circuit coupled to another different phase terminal of the AC power source. During operation in the standby mode, the leakage current circuits route leakage current from a corresponding sub-circuit to one or both other phase terminals of the AC power source. In this way, leakage current from the sub-circuits flows to the AC power source as opposed to the load, thereby advantageously reducing the amount of leakage current received by the load.

In an embodiment of the present technology, a circuit breaker is provided. The circuit breaker may include switching circuitry coupled to a load and to an alternating current (AC) voltage supply. The switching circuitry may include a first-phase circuit, a second-phase circuit, and a third-phase circuit. Each of the first-phase, second-phase, and third-phase circuits includes a first switch including a first terminal coupled to a respective phase terminal of the load, and a second terminal, a second switch including a first terminal coupled to the second terminal of the first switch, and a second terminal coupled to a respective phase terminal of the AC voltage supply, a first leakage current circuit including a first terminal coupled to the second terminal of the first switch, and a second terminal coupled to a first of two other phase terminals of the AC voltage supply, and a second leakage current circuit including a first terminal coupled to the second terminal of the first switch, and a second terminal coupled to a second of the two other phase terminals of the AC voltage supply. In a standby mode of the circuit breaker, each of the first switches is closed, each of the second switches is off, and switches of each of the first and second leakage current circuits are on. In this way, the leakage current circuits allow leakage current flow from at least one respective phase terminal of the load to one or more of two other phase terminals of the AC voltage supply based at least in part on voltage potentials between the phase terminals of the load and the phase terminals of the AC voltage supply.

In another embodiment, a method is provided that includes determining a closed state of a disconnect switch of a circuit breaker and an open state of a current control switch of the circuit breaker. The respective states of the disconnect and current control switches enable a standby mode of the circuit breaker that includes switching circuitry coupled to a load and to an AC voltage supply. The switching circuitry may include a first-phase circuit, a second-phase circuit, and a third-phase circuit. Each of the first-phase, second-phase, and third-phase circuits includes a first switch including a first terminal coupled to a respective phase terminal of the load, and a second terminal, a second switch including a first terminal coupled to the second terminal of the first switch, and a second terminal coupled to a respective phase terminal of the AC voltage supply, a first leakage current circuit including a first terminal coupled to the second terminal of the first switch, and a second terminal coupled to a first of two other phase terminals of the AC voltage supply, and a second leakage current circuit including a first terminal coupled to the second terminal of the first switch, and a second terminal coupled to a second of the two other phase terminals of the AC voltage supply. In response to the circuit breaker being enabled in the standby mode, the method includes providing, via processing circuitry, signals to switches of the first and second leakage current circuits of each of the first-phase, second-phase, and third-phase circuits allowing leakage current flow from at least one respective phase terminal of the load to one or more of two other phase terminals of the AC voltage supply based at least in part on voltage potentials between the phase terminals of the load and the phase terminals of the AC voltage supply.

Advantageously, the disclosed circuit breaker, and corresponding methods of operation, can reduce leakage current to loads that is produced by solid-state switching components of the circuit breaker without the need for high-quality, expensive materials and components. The leakage current reduction may occur automatically due to the design of the circuitry and the inherent operation of the leakage circuit components. Additionally, or instead, the leakage circuits may be managed via processing circuitry to control leakage current flow and advantageously prevent or reduce reverse leakage current flow.

While many of the embodiments described herein relate to circuit breakers and specific components thereof, the leakage current routing and reduction techniques may be applicable to various other devices and circuits operable in three-phase power applications, and to circuit breakers and other such devices having different types of solid-state switching elements.

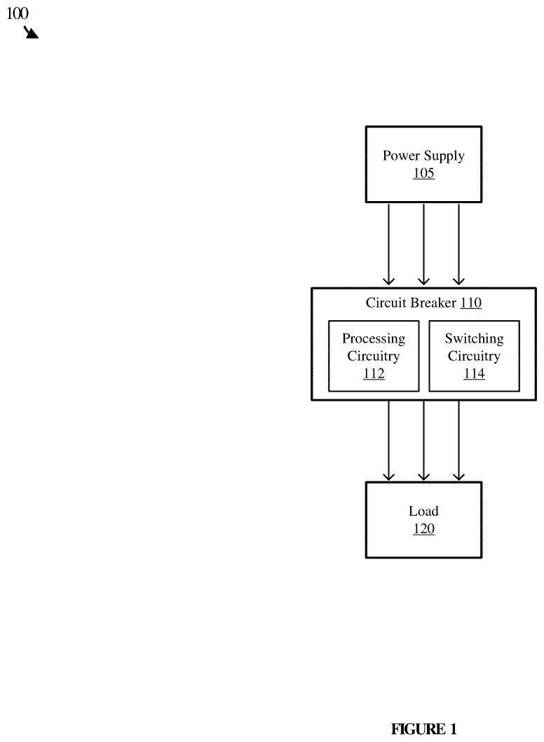

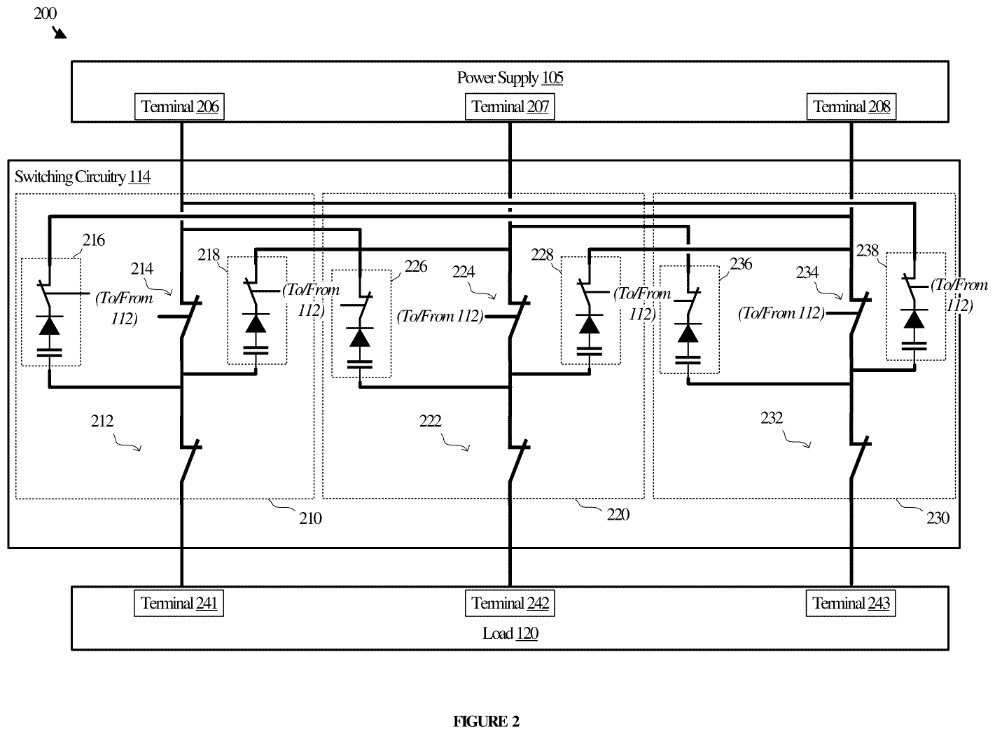

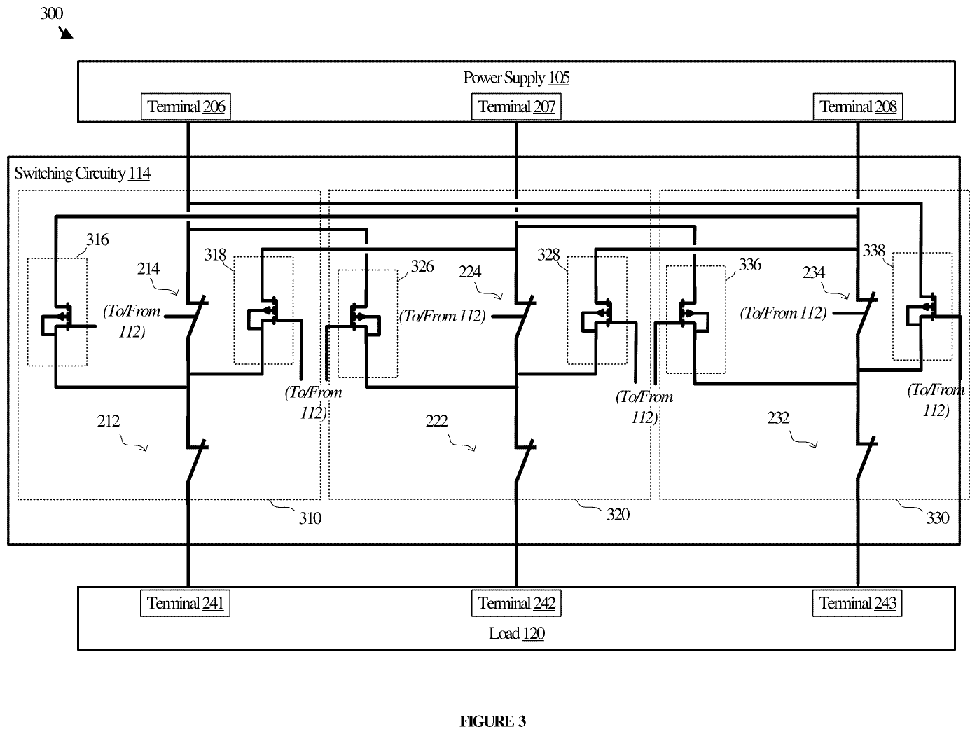

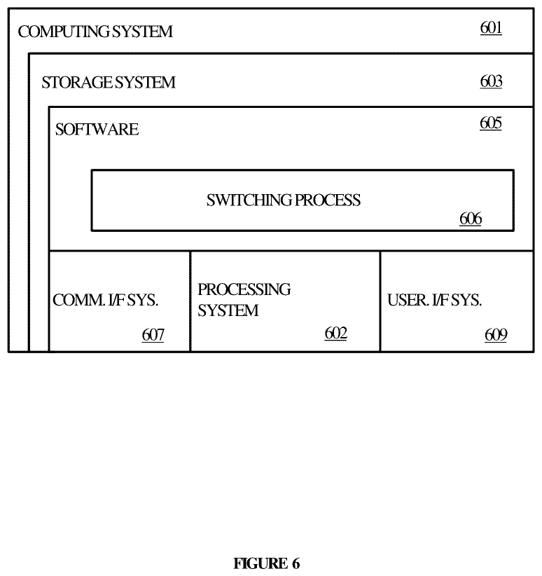

Moving now to the Figures, FIG. 1 illustrates an example operating environment in accordance with some embodiments of the present technology. FIG. 1 includes operating environment 100, which is representative of an environment in which industrial and commercial processes may be performed. Operating environment 100 includes power supply 105, circuit breaker 110, and load 120. Circuit breaker 110 includes processing circuitry 112 and switching circuitry 114, which both include additional elements omitted from FIG. 1 for the sake of simplicity. Examples of switching circuitry 114 are shown and described in FIGS. 2 and 3 below. An example of processing circuitry 112 is shown and described in FIG. 6 below.

In operating environment 100, power supply 105 is representative of an alternating current (AC) power source. For example, power supply 105 is representative of AC mains electricity capable of producing power categorized under Class 1 or Class 2 power of the National Electrical Code (NEC). Power supply 105 is coupled to circuit breaker 110 and provides power to load 120 via circuit breaker 110. More specifically, power supply 105 includes three phase-terminals coupled to three terminals of circuit breaker 110. Each phase-terminal corresponds to a phase of three-phase AC power produced by power supply 105.

Load 120 is representative of a system or device operating in an industrial, commercial, industrial automation, or similar environment. For example, load 120 includes a motor, a drive, a circuit, or any other industrial, commercial, or electrical device, as well as combinations and variations thereof. Load 120 includes three input terminals (also referred to as phase terminals) coupled to three output terminals of circuit breaker 110. Each of the input terminals of load 120 corresponds to a phase of three-phase AC power supplied to load 120 by power supply 105 via circuit breaker 110.

Circuit breaker 110 is representative of a solid-state circuit breaker capable of receiving power from power supply 105 and providing the power to load 120 to enable operations of load 120. To do so, circuit breaker 110 includes switching circuitry 114, and processing circuitry 112, which may control elements of switching circuitry 114 to allow current flow from power supply 105 to load 120 at certain times and prevent current flow from power supply 105 to load 120 at other times.

Processing circuitry 112 is representative of one or more processors, processing cores, or processing circuits capable of interfacing with power supply 105 to receive power from power supply 105, monitoring the current and voltage of power supply 105, monitoring the current and voltage within circuit breaker 110, monitoring the current and voltage to load 120, and transmitting signals to switching circuitry 114 to control states of components of switching circuitry 114, and thereby, controlling current flow through switching circuitry 114. Processing circuitry 112 may receive power from power supply 105 (or an external power supply), receive inputs based on the voltage/current from power supply 105 and/or the voltage/current within circuit breaker 110, and generate and output the signals based on the inputs. In some embodiments, processing circuitry 112 receives the inputs and provides the output signals to elements of switching circuitry 114 via a wired or wireless communication network. Examples of such processor(s) of processing circuitry 112 include—but are not limited to—microcontrollers, microprocessors, general purpose processing units, central processing units (CPUs), graphical processing units (GPUs), digital signal processors (DSPs), application specific processors or circuits (e.g., ASICs), and logic devices (e.g., FPGAs), as well as any other type of processing device, combinations, or variations thereof.

Switching circuitry 114 is representative of various mechanical, electrical, and/or electromechanical elements capable of interfacing with power supply 105 to receive power from power supply 105, with processing circuitry 112 to receive the signals from processing circuitry 112, and with load 120 to provide power to load 120 at various times. In various examples, switching circuitry 114 includes three phase circuits, each corresponding to a phase of the three-phase AC power provided by power supply 105, and each including leakage current circuits. Each phase circuit is coupled to a terminal of power supply 105 and to a corresponding terminal of load 120.

Referring to a single phase circuit for the sake of simplicity and brevity, the phase circuit includes a disconnect switch, a solid-state switch, and two leakage current circuits. In various embodiments, the disconnect switch is representative of a mechanical or electromechanical switch that may be mechanically turned to open (i.e., turn off) and close (i.e., turn on) the disconnect switch. For example, the disconnect switch may be controlled by a knob, switch, or button on circuit breaker 110 that can be physically turned or pressed by an operator of circuit breaker 110. When the disconnect switch is opened, circuit breaker 110 is turned off (i.e., in the off mode) preventing current flow from power supply 105 to load 120. When the disconnect switch is closed, circuit breaker 110 is turned on (i.e., in the on mode) or operated in a standby mode based on the state of the solid-state switch.

In various embodiments, the solid-state switch may be controlled by processing circuitry 112 to transition between open and closed states. For example, the solid-state switch may be a transistor, such as a metal-oxide semiconductor field-effect transistor (MOSFET), a bipolar junction transistor (BJT), a junction field-effect transistor (JFET), an insulated-gate bipolar transistor (IGBT), or the like, as well as combinations and variations thereof. In such embodiments in which the solid-state switch includes a transistor, the transistor may include a first current path terminal (e.g., a drain), a second current path terminal (e.g., a source), and a control terminal (e.g., a gate). In some embodiments, the transistor may additionally include a body terminal.

When the disconnect switch is closed, and the solid-state switch is on (i.e., closed, i.e., operates as a closed switch), circuit breaker 110 is turned on allowing current flow from power supply 105 to load 120 via circuit breaker 110. When the disconnect switch is closed, and the solid-state switch is off (i.e., open, i.e., operates as an open switch, circuit breaker 110 operates in the standby mode preventing current flow from power supply 105 to load 120 while still allowing processing circuitry 112 to monitor for fault conditions.

In operation in the standby mode, the solid-state switch may leak current based on the materials of the solid-state switch and/or based on the operational state of the solid-state switch (e.g., a high-impedance blocking operational state), which may be problematic to load 120, among other elements of operating environment 100. To address the leakage current issues, each phase circuit includes the two leakage current circuits. Each leakage current circuit includes one or more elements, such as transistors, diodes, capacitors, resistors, thyristors, and the like, as well as combinations and variations thereof. The leakage current circuits are capable of routing leakage current from a respective solid-state switch to another phase terminal of power supply 105. In this way, the leakage current can flow to power supply 105 instead of load 120. FIGS. 2 and 3 that follow include operating environments 200 and 300, which include example elements and topologies of circuit breaker 110.

FIG. 2 illustrates an example operating environment in accordance with some embodiments of the present technology. FIG. 2 includes operating environment 200, which includes power supply 105, switching circuitry 114 of circuit breaker 110, and load 120. Power supply 105 includes terminals 206, 207, and 208. Switching circuitry 114 includes phase circuit 210, phase circuit 220, and phase circuit 230. Load 120 includes terminals 241, 242, and 243.

Terminals 206, 207, and 208 are phase terminals of power supply 105 each corresponding to one phase of three-phase AC power produced by power supply 105. Particularly, terminal 206 corresponds to a first phase of the three-phase AC power, terminal 207 corresponds to a second phase of the three-phase AC power 120-degrees out-of-phase relative to the first phase, and terminal 208 corresponds to a third phase of the three-phase AC power 120-degrees out-of-phase relative to the first and second phases. Similarly, terminals 241, 242, and 243 are phase terminals of load 120 each corresponding to a respective one of the three-phases of AC power produced by power supply 105.

The AC power is provided from the phase terminals of power supply 105 to corresponding phase terminals of load 120 via respective phase circuits of switching circuitry 114. More specifically, terminals 206 and 241 are coupled to a first phase circuit 210, and as such, power is provided from terminal 206 to terminal 241 via phase circuit 210. Terminals 207 and 242 are coupled to a second phase circuit 220, and as such, power is provided from terminal 207 to terminal 242 via phase circuit 220. Terminals 208 and 243 are coupled to a third phase circuit 230, and as such, power is provided from terminal 208 to terminal 243 via phase circuit 230.

Phase circuits 210, 220, and 230 each include multiple switches and leakage current circuits. More specifically, phase circuit 210 includes switch 212, switch 214, leakage current circuit 216, and leakage current circuit 218, phase circuit 220 includes switch 222, switch 224, leakage current circuit 226, and leakage current circuit 228, and phase circuit 230 includes switch 232, switch 234, leakage current circuit 236, and leakage current circuit 238.

In various embodiments, switches 212, 222, and 232 are representative of disconnect switches that may be mechanically or electromechanically opened and closed to turn circuit breaker 110 off and on, respectively. In some such embodiments, switches 212, 222, and 232 are operated in unison such that when one of switches 212, 222, and 232 are opened or closed, the other switches also open or close. By way of example, switches 212, 222, and 232 may be controlled by a knob, switch, or button on circuit breaker 110 that can be physically turned or pressed by an operator of circuit breaker 110.

In various embodiments, switches 214, 224, and 234 are representative of solid-state switches that may be controlled by processing circuitry 112 to turn off and on, or in other words, transition between open and closed states, respectively. Like the disconnect switches, in some such embodiments, switches 214, 224, and 234 are operated in unison such that when one of switches 214, 224, and 234 is turned off or on, the other switches also turn off or on, respectively. In various embodiments, switches 214, 224, and 234 are transistors controllable by signals provided by processing circuitry 112. Examples of the transistors include metal-oxide semiconductor field-effect transistors (MOSFETs), bipolar junction transistors (BJTs), junction field-effect transistors (JFETs), insulated-gate bipolar transistors (IGBTs), or the like, as well as combinations and variations thereof. In such embodiments in which switches 214, 224, and 234 include a transistor, the transistors may each include a first current path terminal (e.g., a drain), a second current path terminal (e.g., a source), and a control terminal (e.g., a gate). In some embodiments, the transistors may additionally include a body terminal.

In various embodiments, leakage current circuits 216, 218, 226, 228, 236, and 238 are representative of current source circuits that include various components capable of routing leakage current flowing from switches of respective phase circuits to power supply 105. More specifically, leakage current circuit 216 routes leakage current from switch 214 to terminal 208 of power supply 105, leakage current circuit 216 routes leakage current from switch 214 to terminal 207 of power supply 105, leakage current circuit 226 routes leakage current from switch 224 to terminal 206 of power supply 105, leakage current circuit 228 routes leakage current from switch 224 to terminal 208 of power supply 105, leakage current circuit 236 routes leakage current from switch 234 to terminal 207 of power supply 105, and leakage current circuit 238 routes leakage current from switch 234 to terminal 206 of power supply 105. To do so, each leakage current circuit includes a capacitor, a diode, and a switch coupled in series. Due to the configuration of these discrete components, current flow is prevented from flowing from the terminals of power supply 105 to the terminals of load 120 through the leakage current circuits.

Referring now to the topology of phase circuit 210, switch 212 includes a first terminal coupled to terminal 241 of load 120, and a second terminal coupled to a first terminal of switch 214, switch 214 includes the first terminal, a second terminal coupled to terminal 206 of power supply 105, and a third terminal coupled to processing circuitry 112, leakage current circuit 216 includes an input terminal coupled to the first terminal of switch 214, and an output terminal coupled to terminal 208 of power supply 105, and leakage current circuit 218 includes an input terminal coupled to the first terminal of switch 214, and an output terminal coupled to terminal 207 of power supply 105.

Leakage current circuit 216 includes a capacitor having a first terminal (the input terminal of leakage current circuit 216) coupled to the first terminal of switch 214, and a second terminal coupled to an anode terminal of a diode, a diode having the anode terminal, and a cathode terminal coupled to a first terminal of a switch (e.g., a transistor), and the switch having the first terminal, a second terminal (the output terminal of leakage current circuit 216) coupled to terminal 208, and a third terminal coupled to processing circuitry 112.

Leakage current circuit 218 includes a capacitor having a first terminal (the input terminal of leakage current circuit 218) coupled to the first terminal of switch 214, and a second terminal coupled to an anode terminal of a diode, a diode having the anode terminal, and a cathode terminal coupled to a first terminal of a switch (e.g., a transistor), and the switch having the first terminal, a second terminal (the output terminal of leakage current circuit 218) coupled to terminal 207, and a third terminal coupled to processing circuitry 112.

Referring next to the topology of phase circuit 220, switch 222 includes a first terminal coupled to terminal 242 of load 120, and a second terminal coupled to a first terminal of switch 224, switch 224 includes the first terminal, a second terminal coupled to terminal 207 of power supply 105, and a third terminal coupled to processing circuitry 112, leakage current circuit 226 includes an input terminal coupled to the first terminal of switch 224, and an output terminal coupled to terminal 206 of power supply 105, and leakage current circuit 228 includes an input terminal coupled to the first terminal of switch 224, and an output terminal coupled to terminal 208 of power supply 105.

Leakage current circuit 226 includes a capacitor having a first terminal (the input terminal of leakage current circuit 226) coupled to the first terminal of switch 224, and a second terminal coupled to an anode terminal of a diode, a diode having the anode terminal, and a cathode terminal coupled to a first terminal of a switch (e.g., a transistor), and the switch having the first terminal, a second terminal (the output terminal of leakage current circuit 226) coupled to terminal 206, and a third terminal coupled to processing circuitry 112.

Leakage current circuit 228 includes a capacitor having a first terminal (the input terminal of leakage current circuit 228) coupled to the first terminal of switch 224, and a second terminal coupled to an anode terminal of a diode, a diode having the anode terminal, and a cathode terminal coupled to a first terminal of a switch (e.g., a transistor), and the switch having the first terminal, a second terminal (the output terminal of leakage current circuit 228) coupled to terminal 208, and a third terminal coupled to processing circuitry 112.

Referring next to the topology of phase circuit 230, switch 232 includes a first terminal coupled to terminal 242 of load 120, and a second terminal coupled to a first terminal of switch 234, switch 234 includes the first terminal, a second terminal coupled to terminal 208 of power supply 105, and a third terminal coupled to processing circuitry 112, leakage current circuit 236 includes an input terminal coupled to the first terminal of switch 234, and an output terminal coupled to terminal 207 of power supply 105, and leakage current circuit 238 includes an input terminal coupled to the first terminal of switch 234, and an output terminal coupled to terminal 206 of power supply 105.

Leakage current circuit 236 includes a capacitor having a first terminal (the input terminal of leakage current circuit 236) coupled to the first terminal of switch 234, and a second terminal coupled to an anode terminal of a diode, a diode having the anode terminal, and a cathode terminal coupled to a first terminal of a switch (e.g., a transistor), and the switch having the first terminal, a second terminal (the output terminal of leakage current circuit 236) coupled to terminal 207, and a third terminal coupled to processing circuitry 112.

Leakage current circuit 238 includes a capacitor having a first terminal (the input terminal of leakage current circuit 238) coupled to the first terminal of switch 234, and a second terminal coupled to an anode terminal of a diode, a diode having the anode terminal, and a cathode terminal coupled to a first terminal of a switch (e.g., a transistor), and the switch having the first terminal, a second terminal (the output terminal of leakage current circuit 238) coupled to terminal 206, and a third terminal coupled to processing circuitry 112.

In operation of switching circuitry 114, when switches 212, 222, and 232 are opened, circuit breaker 110 is turned off preventing current flow from power supply 105 to load 120. When switches 212, 222, and 232 are closed, circuit breaker 110 is turned on or operated in a standby mode, the selection of the mode being based on the state of switches 214, 224, and 234. For example, when switches 212, 222, and 232 are closed, and switches 214, 224, and 234 are turned on (i.e., closed, i.e., operated as closed switches based on signals provided by processing circuitry 112), circuit breaker 110 is turned on allowing current flow from power supply 105 to load 120 via the phase circuits of switching circuitry 114. When operating circuit breaker 110 in the on mode, the switches of leakage current circuits 216, 218, 226, 228, 236, and 238 are turned off (i.e., open, i.e., operated as open switches based on signals provided by processing circuitry 112). When switches 212, 222, and 232 are closed, and switches 214, 224, and 234 are open (i.e., operated as a high-impedance switches based on signals provided by processing circuitry 112), circuit breaker 110 operates in the standby mode preventing current flow from terminal 206 of power supply 105 to terminal 241 of load 120 while still allowing processing circuitry 112 to monitor for fault conditions.

While in the standby mode, processing circuitry 112 also provides signals to one or more leakage current circuits 216, 218, 226, 228, 236, and 238, or more specifically, to the switches thereof, to provide leakage current reduction capabilities described herein. In the configuration shown in operating environment 200, and with discrete components in the leakage current circuits as shown in operating environment 200, processing circuitry 112 may provide signals to all of the switches of the leakage current circuits to close the switches in the standby mode. When the leakage current circuit switches are turned on, the leakage current circuits allow current flow in the direction from load 120 to power supply 105 automatically based on the inherent operations of the capacitor-diode-switch configuration of the leakage current circuits. The amount of leakage current flow through a leakage current circuit at a given time may be based on the voltage of power supply 105 at each of terminals 206, 207, and 208. In some embodiments, the amount of leakage current flow may be based on voltage potential differences between terminals of power supply 105 and terminals of load 120.

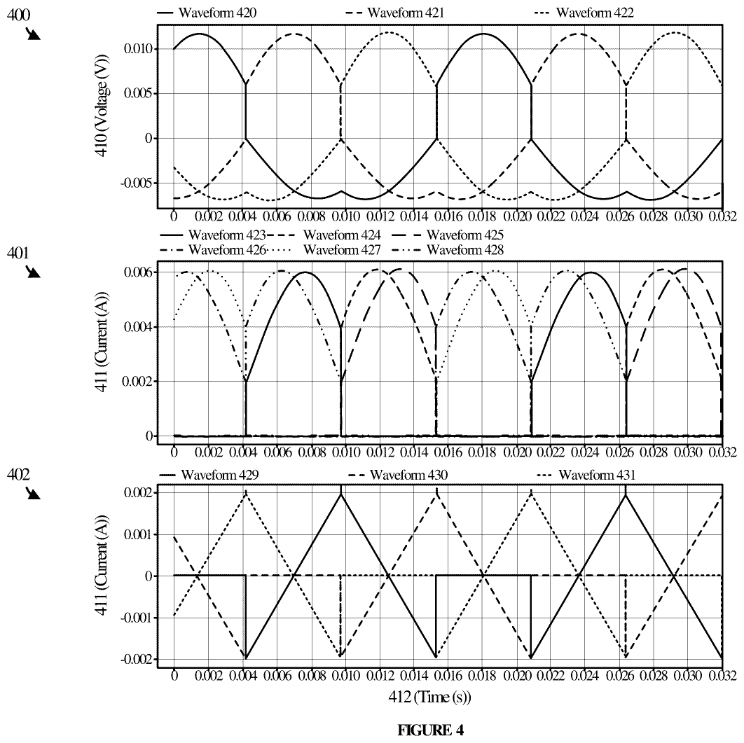

By way of example, at a first time when the voltage at terminal 206 of power supply 105 includes the lowest voltage relative to the voltages at the terminals of power supply 105, leakage current produced by switch 224 may flow from switch 224 through leakage current circuit 226 to terminal 206, and leakage current produced by switch 234 may flow from switch 234 through leakage current circuit 238 to terminal 206. As the voltage at terminal 206 increases, the voltage at terminal 207 of power supply 105 may next decrease to the lowest voltage relative to the voltages at the terminals of power supply 105. At this second time, leakage current produced by switch 234 may flow from switch 234 through leakage current circuit 236 to terminal 207, and leakage current produced by switch 214 may flow from switch 214 through leakage current circuit 218 to terminal 207. As the voltage at terminal 207 increases, the voltage at terminal 208 of power supply 105 may next decrease to the lowest voltage among the voltages of the terminals of power supply 105. At this third time, leakage current produced by switch 214 may flow from switch 214 through leakage current circuit 216 to terminal 208, and leakage current produced by switch 224 may flow from switch 224 through leakage current circuit 228 to terminal 208. This pattern may continue until switching circuitry 114 changes modes (e.g., from the standby mode to the on mode, from the standby mode to the off mode) based on signals from processing circuitry 112. Example waveforms demonstrating the above pattern is shown and described below with respect to FIG. 4.

In some embodiments, other sequences of voltages and leakage current flow may be contemplated. In some embodiments, additional, fewer, or different components may be included in switching circuitry 114, and in particular, in the leakage current circuits thereof. For example, instead of a capacitor-diode-switch combination, the leakage current circuits may include a capacitor, and a silicon-controlled rectifier (SCR) coupled in series. In such an example, the SCR may be coupled to processing circuitry 112 for control thereof. Other types of diodes, thyristors, resistors, or other current sourcing or impeding devices, as well as combinations and variations thereof, may be contemplated.

FIG. 3 illustrates an example operating environment in accordance with some embodiments of the present technology. FIG. 3 includes operating environment 300, which includes power supply 105, switching circuitry 114 of circuit breaker 110, and load 120. Power supply 105 includes terminals 206, 207, and 208. Switching circuitry 114 includes phase circuit 310, phase circuit 320, and phase circuit 330. Load 120 includes terminals 241, 242, and 243.

Terminals 206, 207, and 208 are phase terminals of power supply 105 each corresponding to one phase of three-phase AC power produced by power supply 105. Particularly, terminal 206 corresponds to a first phase of the three-phase AC power, terminal 207 corresponds to a second phase of the three-phase AC power 120-degrees out-of-phase relative to the first phase, and terminal 208 corresponds to a third phase of the three-phase AC power 120-degrees out-of-phase relative to the first and second phases. Similarly, terminals 241, 242, and 243 are phase terminals of load 120 each corresponding to a respective one of the three-phases of AC power produced by power supply 105.

The AC power is provided from the phase terminals of power supply 105 to corresponding phase terminals of load 120 via respective phase circuits of switching circuitry 114. More specifically, terminals 206 and 241 are coupled to a first phase circuit 310, and as such, power is provided from terminal 206 to terminal 241 via phase circuit 310. Terminals 207 and 242 are coupled to a second phase circuit 320, and as such, power is provided from terminal 207 to terminal 242 via phase circuit 320. Terminals 208 and 243 are coupled to a third phase circuit 330, and as such, power is provided from terminal 208 to terminal 243 via phase circuit 330.

Phase circuits 310, 320, and 330 each include multiple switches and leakage current circuits. More specifically, phase circuit 310 includes switch 212, switch 214, leakage current circuit 316, and leakage current circuit 318, phase circuit 320 includes switch 222, switch 224, leakage current circuit 326, and leakage current circuit 328, and phase circuit 330 includes switch 232, switch 234, leakage current circuit 336, and leakage current circuit 338.

In various embodiments, switches 212, 222, and 232 are representative of disconnect switches that may be mechanically or electromechanically opened and closed to turn circuit breaker 110 off and on, respectively. In some such embodiments, switches 212, 222, and 232 are operated in unison such that when one of switches 212, 222, and 232 are opened or closed, the other switches also open or close. By way of example, switches 212, 222, and 232 may be controlled by a knob, switch, or button on circuit breaker 110 that can be physically turned or pressed by an operator of circuit breaker 110.

In various embodiments, switches 214, 224, and 234 are representative of solid-state switches that may be controlled by processing circuitry 112 to turn off and on, or in other words, transition between open and closed states, respectively. Like the disconnect switches, in some such embodiments, switches 214, 224, and 234 are operated in unison such that when one of switches 214, 224, and 234 is turned off or on, the other switches also turn off or on, respectively. In various embodiments, switches 214, 224, and 234 are transistors controllable by signals provided by processing circuitry 112. Examples of the transistors include metal-oxide semiconductor field-effect transistors (MOSFETs), bipolar junction transistors (BJTs), junction field-effect transistors (JFETs), insulated-gate bipolar transistors (IGBTs), or the like, as well as combinations and variations thereof. In such embodiments in which switches 214, 224, and 234 include a transistor, the transistors may each include a first current path terminal (e.g., a drain), a second current path terminal (e.g., a source), and a control terminal (e.g., a gate). In some embodiments, the transistors may additionally include a body terminal.

In various embodiments, leakage current circuits 316, 318, 326, 328, 336, and 338 are representative of current source circuits that include one or more components capable of routing leakage current flowing from switches of respective phase circuits to power supply 105. More specifically, leakage current circuit 316 routes leakage current from switch 214 to terminal 208 of power supply 105, leakage current circuit 316 routes leakage current from switch 214 to terminal 207 of power supply 105, leakage current circuit 326 routes leakage current from switch 224 to terminal 206 of power supply 105, leakage current circuit 328 routes leakage current from switch 224 to terminal 208 of power supply 105, leakage current circuit 336 routes leakage current from switch 234 to terminal 207 of power supply 105, and leakage current circuit 338 routes leakage current from switch 234 to terminal 206 of power supply 105. To do so, each leakage current circuit includes a solid-state switch (e.g., a transistor, e.g., a MOSFET) controlled by processing circuitry 112. Due to the configuration of these discrete components, current flow is prevented from flowing from the terminals of power supply 105 to the terminals of load 120 through the leakage current circuits.

Referring now to the topology of phase circuit 310, switch 212 includes a first terminal coupled to terminal 241 of load 120, and a second terminal coupled to a first terminal of switch 214, switch 214 includes the first terminal, a second terminal coupled to terminal 206 of power supply 105, and a third terminal coupled to processing circuitry 112, leakage current circuit 316 includes an input terminal coupled to the first terminal of switch 214, and an output terminal coupled to terminal 208 of power supply 105, and leakage current circuit 318 includes an input terminal coupled to the first terminal of switch 214, and an output terminal coupled to terminal 207 of power supply 105.

Leakage current circuit 316 includes a switch having a first current path terminal (the input terminal of leakage current circuit 316) coupled to the first terminal of switch 214, a control terminal coupled to processing circuitry 112, a body terminal coupled to the first current path terminal of the switch, and a second current path terminal (the output terminal of leakage current circuit 316) coupled to terminal 208.

Leakage current circuit 318 includes a switch having a first current path terminal (the input terminal of leakage current circuit 318) coupled to the first terminal of switch 214, a control terminal coupled to processing circuitry 112, a body terminal coupled to the first current path terminal of the switch, and a second current path terminal (the output terminal of leakage current circuit 318) coupled to terminal 207.

Referring next to the topology of phase circuit 320, switch 222 includes a first terminal coupled to terminal 242 of load 120, and a second terminal coupled to a first terminal of switch 224, switch 224 includes the first terminal, a second terminal coupled to terminal 207 of power supply 105, and a third terminal coupled to processing circuitry 112, leakage current circuit 326 includes an input terminal coupled to the first terminal of switch 224, and an output terminal coupled to terminal 206 of power supply 105, and leakage current circuit 328 includes an input terminal coupled to the first terminal of switch 224, and an output terminal coupled to terminal 208 of power supply 105.

Leakage current circuit 326 includes a switch having a first current path terminal (the input terminal of leakage current circuit 326) coupled to the first terminal of switch 224, a control terminal coupled to processing circuitry 112, a body terminal coupled to the first current path terminal of the switch, and a second current path terminal (the output terminal of leakage current circuit 326) coupled to terminal 206.

Leakage current circuit 328 includes a switch having a first current path terminal (the input terminal of leakage current circuit 328) coupled to the first terminal of switch 224, a control terminal coupled to processing circuitry 112, a body terminal coupled to the first current path terminal of the switch, and a second current path terminal (the output terminal of leakage current circuit 328) coupled to terminal 208.

Referring next to the topology of phase circuit 330, switch 232 includes a first terminal coupled to terminal 243 of load 120, and a second terminal coupled to a first terminal of switch 234, switch 234 includes the first terminal, a second terminal coupled to terminal 208 of power supply 105, and a third terminal coupled to processing circuitry 112, leakage current circuit 336 includes an input terminal coupled to the first terminal of switch 234, and an output terminal coupled to terminal 207 of power supply 105, and leakage current circuit 338 includes an input terminal coupled to the first terminal of switch 234, and an output terminal coupled to terminal 206 of power supply 105.

Leakage current circuit 336 includes a switch having a first current path terminal (the input terminal of leakage current circuit 336) coupled to the first terminal of switch 234, a control terminal coupled to processing circuitry 112, a body terminal coupled to the first current path terminal of the switch, and a second current path terminal (the output terminal of leakage current circuit 336) coupled to terminal 207.

Leakage current circuit 338 includes a switch having a first current path terminal (the input terminal of leakage current circuit 338) coupled to the first terminal of switch 234, a control terminal coupled to processing circuitry 112, a body terminal coupled to the first current path terminal of the switch, and a second current path terminal (the output terminal of leakage current circuit 338) coupled to terminal 206.

In operation of switching circuitry 114, when switches 212, 222, and 232 are opened, circuit breaker 110 is turned off preventing current flow from power supply 105 to load 120. When switches 212, 222, and 232 are closed, circuit breaker 110 is turned on or operated in a standby mode, the selection of the mode being based on the state of switches 214, 224, and 234. For example, when switches 212, 222, and 232 are closed, and switches 214, 224, and 234 are turned on (i.e., closed, i.e., operated as closed switches based on signals provided by processing circuitry 112), circuit breaker 110 is turned on allowing current flow from power supply 105 to load 120 via the phase circuits of switching circuitry 114. When operating circuit breaker 110 in the on mode, the switches of leakage current circuits 316, 318, 326, 328, 336, and 338 are turned off (i.e., open, i.e., operated as open switches based on signals provided by processing circuitry 112). When switches 212, 222, and 232 are closed, and switches 214, 224, and 234 are turned off (i.e., open, i.e., operated as a high-impedance switches based on signals provided by processing circuitry 112), circuit breaker 110 operates in the standby mode preventing current flow from terminal 206 of power supply 105 to terminal 241 of load 120 while still allowing processing circuitry 112 to monitor for fault conditions.

While in the standby mode, processing circuitry 112 also provides signals to one or more leakage current circuits 316, 318, 326, 328, 336, and 338, or more specifically, to the switches thereof, to provide leakage current reduction capabilities described herein. In the configuration shown in operating environment 300, and with solid-state components in the leakage current circuits as shown in operating environment 300, processing circuitry 112 can turn off and on one or more of the switches to prevent and allow, respectively, leakage current flow from one or more of switches 214, 224, and 234 to power supply 105. The selection and sequencing by which processing circuitry 112 turns off and on the switches may be based on the voltage supplied by power supply 105 at each of terminals 206, 207, and 208. More particularly, the selection and sequencing may be based on voltage potential differences between terminals of power supply 105 and terminals of load 120.

By way of example, at a first time when the voltage at terminal 206 of power supply 105 includes the lowest voltage relative to the voltages at the terminals of power supply 105, processing circuitry 112 provides signals to the switches of leakage current circuits 326 and 338 to turn on such that the switches operate as closed switches. Accordingly, leakage current produced by switch 224 may flow from switch 224 through leakage current circuit 326 to terminal 206, and leakage current produced by switch 234 may flow from switch 234 through leakage current circuit 338 to terminal 206.

As the voltage at terminal 206 increases, the voltage at terminal 207 of power supply 105 may next decrease to the lowest voltage among the terminals of power supply 105. At or before this second time, processing circuitry 112 provides signals to the switches of leakage current circuits 326 and 338 to turn off the respective switches. Additionally, processing circuitry 112 provides signals to the switches of leakage current circuits 336 and 318 to turn on the respective switches, such that leakage current produced by switch 234 may flow from switch 234 through leakage current circuit 336 to terminal 207, and leakage current produced by switch 214 may flow from switch 214 through leakage current circuit 318 to terminal 207.

As the voltage at terminal 207 increases, the voltage at terminal 208 of power supply 105 may next decrease to the lowest voltage among the terminals of power supply 105. At or before this third time, processing circuitry 112 provides signals to the switches of leakage current circuits 336 and 318 to turn off the respective switches. Additionally, processing circuitry 112 provides signals to the switches of leakage current circuits 316 and 328 to turn on the respective switches, such that leakage current produced by switch 214 may flow from switch 214 through leakage current circuit 316 to terminal 208, and leakage current produced by switch 224 may flow from switch 224 through leakage current circuit 328 to terminal 208. This pattern may continue until switching circuitry 114 changes modes (e.g., from the standby mode to the on mode, from the standby mode to the off mode) based on signals from processing circuitry 112. Example waveforms demonstrating the above pattern is shown and described below with respect to FIG. 4.

In some embodiments, other sequences of voltages and leakage current flow may be contemplated. For example, processing circuitry 112 may control subsets of the switches to open and close at different times and remain in certain states for different durations.

FIG. 4 illustrates example graphical representations of measurements sensed in a circuit breaker in accordance with some embodiments of the present technology. FIG. 4 includes graphical representations 400, 401, and 402, which each show outputs measured at different points of a system including power supply 105, circuit breaker 110, and load 120, such as one illustrated in operating environments 100, 200, or 300.

More specifically, graphical representation 400 includes waveforms 420, 421, and 422 that show voltage measurements sensed at terminals 206, 207, and 208 of power supply 105, respectively, with respect to voltage 410 and time 412. Graphical representation 401 includes waveforms 423, 424, 425, 426, 427, and 428 that show current measurements sensed at outputs of leakage current circuits of switching circuitry 114 with respect to current 411 and time 412. In particular, waveform 423 corresponds to a current measured at an output of leakage current circuit 218 (e.g., at the cathode terminal of the diode), waveform 424 corresponds to a current measured at an output of leakage current circuit 216, waveform 425 corresponds to a current measured at an output of leakage current circuit 224, waveform 426 corresponds to a current measured at an output of leakage current circuit 226, waveform 427 corresponds to a current measured at an output of leakage current circuit 238, and waveform 428 corresponds to a current measured at an output of leakage current circuit 236. Graphical representation 402 includes waveforms 429, 430, and 431 that show current measurements sensed at terminals 241, 242, and 243 of load 120, respectively, with respect to current 411 and time 412.

The following interchangeably discusses all of the waveforms of graphical representations 400, 401, and 402 in relation to operations of power supply 105, circuit breaker 110, and load 120 with respect to time 412.

To begin, at a first time at zero seconds with respect to time 412, power supply 105 generates a voltage at terminal 206 that may be the lowest voltage among the voltages at the terminals of power supply 105. Since the voltage is a three-phase AC voltage, it follows that at the first time, the voltages generated by power supply 105 at terminals 207 and 208 include voltages out-of-phase relative to the voltage at terminal 206, and are thus greater than the voltage at terminal 206 at the first time. Based on the voltage at terminal 206, positive, non-zero leakage current flows from switch 224 to terminal 206 through leakage current circuit 226 as shown by waveform 426, and non-zero leakage current flows from switch 234 to terminal 206 through leakage current circuit 238 as shown by waveform 427, which produces a positive, non-zero voltage at terminal 206 as shown by waveform 420. Accordingly, the leakage current received at terminals 242 and 243 of load 120 is small (e.g., approximately 1 mA) relative to solutions that do not include the leakage current circuits, as shown by waveforms 420 and 431, respectively.

At a second time at 0.0004 seconds with respect to time 412, the voltage produced by power supply 105 increases. The amount of leakage current routed from switches 224 and 234 to terminal 206 approaches zero based on the voltage potential between the switches and terminal 206 as shown by waveforms 426 and 427, respectively. As such, at this time, the leakage current flowing to terminals 241, 242, and 243 reaches a peak current (e.g., 2 mA) as shown by waveforms 429, 430, and 431, respectively. The peak current may still be a smaller amount of leakage current relative to solutions that do not include the leakage current circuits.

Shortly after the second time, the voltage produced by power supply 105 at terminal 207 decreases to the lowest voltage among the voltages at the terminals of power supply 105. Now that terminal 207 includes the lowest voltage, leakage current circuits 218 and 236 begin routing leakage current from switches 214 and 234, respectively, to terminal 207 as shown by waveforms 423 and 428, respectively, which produces a positive, non-zero voltage at terminal 207 as shown by waveform 421. Accordingly, the leakage current from switches 214 and 234 flowing to terminals 241 and 243 of load 120, respectively, begins to reduce from the peak amount to zero amps (at least temporarily) as shown by waveforms 429 and 431, respectively.

At a third time at 0.01 seconds with respect to time 412, the voltage produced by power supply 105 at terminal 207 increases. The amount of leakage current routed from switches 214 and 234 to terminal 207 approaches zero based on the voltage potential between the switches and terminal 207 as shown by waveforms 423 and 428, respectively. As such, at this time, the leakage current flowing to terminals 241, 242, and 243 reaches the peak current (e.g., 2 mA) as shown by waveforms 429, 430, and 431, respectively.

Shortly after the third time, the voltage produced by power supply 105 at terminal 208 decreases to the lowest voltage among the voltages at the terminals of power supply 105. Now that terminal 208 includes the lowest voltage, leakage current circuits 216 and 228 begin routing leakage current from switches 214 and 224, respectively, to terminal 208 as shown by waveforms 424 and 425, respectively, which produces a positive, non-zero voltage at terminal 208 as shown by waveform 422. Accordingly, the leakage current from switches 214 and 224 flowing to terminals 241 and 242 of load 120, respectively, begins to reduce from the peak amount to zero amps (at least temporarily) as shown by waveforms 429 and 430, respectively.

The above pattern continues as shown by the waveforms of graphical representations 400, 401, and 402. It follows that when one terminal of power supply 105 includes the lowest voltage, leakage circuits of other phase circuits can route leakage current from their respective phase circuits to that terminal of power supply 105 to reduce the amount of leakage current flowing to terminals of load 120. Other patterns or sequencing may also be contemplated to achieve leakage current reduction in a circuit breaker.

While the above discussion refers to elements of operating environment 200, it may be appreciated that such a pattern involving leakage current routing and reduction may also be implemented in the elements of operating environment 300. An extended discussion involving similar sequencing using the leakage current circuits of operating environment 300 is excluded here for the sake of brevity.

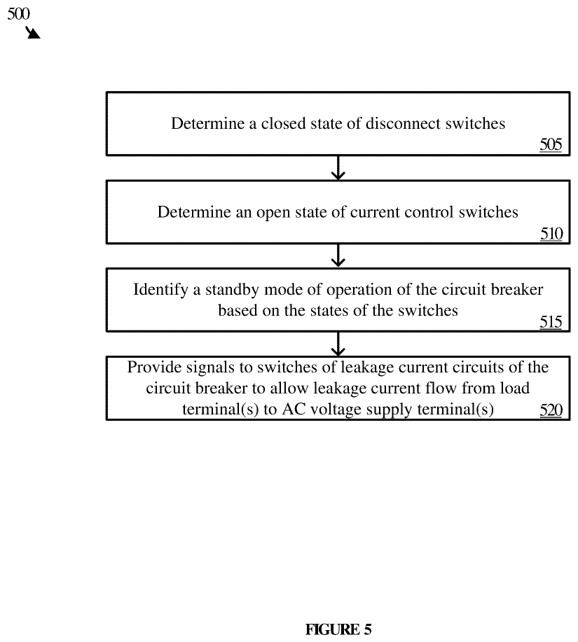

FIG. 5 illustrates a series of steps for controlling switching circuitry of a circuit breaker to route leakage current produced by elements of a circuit breaker to a power supply in accordance with some embodiments of the present technology. FIG. 5 includes process 500, which references elements of operating environments 300 of FIG. 3. In various examples, process 500 may be implemented in hardware, software, firmware, or combinations or variations thereof. For example, process 500 may be implemented in processing circuitry 112 of circuit breaker 110 of operating environments 100, 200, or 300.

To begin, in operation 505, processing circuitry 112 determines a closed state of switches 212, 222, and 232, or the mechanical disconnect switches, of circuit breaker 110. To determine the closed state of the mechanical disconnect switches, processing circuitry 112 may receive measurements of current or voltage sensed at switches 214, 224, and 234, or at terminals 241, 242, and 243 of load 120, and determine that the current or voltage is zero amps or zero volts, respectively. Accordingly, processing circuitry 112 determines that the circuit breaker is off.

In operation 510, processing circuitry 112 determines an off (i.e., open) state of switches 214, 224, and 234, or current control switches, of circuit breaker 110. In some embodiments, processing circuitry 112 determines the off state of the current control switches based on the measurements of current or voltage sensed at switches 214, 224, and 234, or at terminals 241, 242, and 243 of load 120. In some embodiments, processing circuitry 112 determines the off state of the current control switches based on signals (e.g., values thereof) being provided to the current control switches by processing circuitry 112. In some embodiments, processing circuitry 112 determines the off state of the current control switches based on a previously detected fault condition at circuit breaker 110.

In operation 515, processing circuitry 112 identifies that circuit breaker 110 operates in the standby mode based on the states of the mechanical disconnect switches and the current control switches. As a result of being in the standby mode, processing circuitry 112 obtains voltage measurements at terminals 206, 207, and 208 of power supply 105. Based on the voltage measurements and voltage potential differences between the terminals of power supply 105 and terminals of load 120, in operation 520, processing circuitry 112 provides signals to switches of leakage current circuits of switching circuitry 114 of circuit breaker 110 to allow leakage current flow from subsets of terminals of load 120 to one or more terminals of power supply 105.

By way of example, at a first time when the voltage at terminal 206 of power supply 105 includes the lowest voltage relative to the voltages at the terminals of power supply 105, processing circuitry 112 provides signals to the switches of leakage current circuits 326 and 338 such that the switches turn on and operate as closed switches. Accordingly, leakage current produced by switch 224 may flow from switch 224 through leakage current circuit 326 to terminal 206, and leakage current produced by switch 234 may flow from switch 234 through leakage current circuit 338 to terminal 206.

As the voltage at terminal 206 increases, the voltage at terminal 207 of power supply 105 decreases to the lowest voltage among the voltages at terminals of power supply 105. At or before this second time, processing circuitry 112 provides signals to the switches of leakage current circuits 326 and 338 to turn off (i.e., open) the respective switches. Additionally, processing circuitry 112 provides signals to the switches of leakage current circuits 336 and 318 to close the respective switches, such that leakage current produced by switch 234 may flow from switch 234 through leakage current circuit 336 to terminal 207, and leakage current produced by switch 214 may flow from switch 214 through leakage current circuit 318 to terminal 207.

As the voltage at terminal 207 increases, the voltage at terminal 208 of power supply 105 decreases to the lowest voltage. At or before this third time, processing circuitry 112 provides signals to the switches of leakage current circuits 336 and 318 to turn off the respective switches. Additionally, processing circuitry 112 provides signals to the switches of leakage current circuits 316 and 328 to turn on the respective switches, such that leakage current produced by switch 214 may flow from switch 214 through leakage current circuit 316 to terminal 208, and leakage current produced by switch 224 may flow from switch 224 through leakage current circuit 328 to terminal 208. This pattern may continue until switching circuitry 114 changes modes (e.g., from the standby mode to the on mode, from the standby mode to the off mode) based on signals from processing circuitry 112.

FIG. 6 illustrates computing system 601 to perform mode transition operations, switch state transition and sequencing operations, and other leakage current reduction operations according to an implementation of the present technology. Computing system 601 is representative of any system or collection of systems with which the various operational architectures, processes, scenarios, and sequences disclosed herein for circuit breaker mode selection and operation may be employed. Computing system 601 may be implemented as a single apparatus, system, or device or may be implemented in a distributed manner as multiple apparatuses, systems, or devices. Computing system 601 includes, but is not limited to, processing system 602, storage system 603, software 605, communication interface system 607, and user interface system 609 (optional). Processing system 602 is operatively coupled with storage system 603, communication interface system 607, and user interface system 609. Computing system 601 may be representative of a cloud computing device, distributed computing device, or the like.

Processing system 602 loads and executes software 605 from storage system 603. Software 605 includes and implements switching process 606, which is representative of any of the circuit breaker mode transition, circuit breaker switch control, and circuit breaker switching sequencing, and other processes discussed with respect to the preceding Figures. When executed by processing system 602 to provide leakage current reduction and switching functions, software 605 directs processing system 602 to operate as described herein for at least the various processes, operational scenarios, and sequences discussed in the foregoing implementations. Computing system 601 may optionally include additional devices, features, or functionality not discussed for purposes of brevity.

Referring still to FIG. 6, processing system 602 may comprise a micro-processor and other circuitry that retrieves and executes software 605 from storage system 603. Processing system 602 may be implemented within a single processing device but may also be distributed across multiple processing devices or sub-systems that cooperate in executing program instructions. Examples of processing system 602 include general purpose central processing units, graphical processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller, capable of communicating with processing system 602 or possibly other systems.

Software 605 (including switching process 606) may be implemented in program instructions and among other functions may, when executed by processing system 602, direct processing system 602 to operate as described with respect to the various operational scenarios, sequences, and processes illustrated herein. For example, software 605 may include program instructions for implementing a circuit breaker mode switching and switch control process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software, or other application software. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to provide signals to switches of a circuit breaker to control modes thereof as described herein. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A circuit breaker comprising:
processing circuitry; and
switching circuitry coupled to the processing circuitry, to an alternating current (AC) voltage supply, and to a load, and comprising a first-phase circuit, a second-phase circuit, and a third-phase circuit, wherein each of the first-phase, second-phase, and third-phase circuits includes:
a first switch including a first terminal coupled to a respective phase terminal of the load, and a second terminal,
a second switch including a first terminal coupled to the second terminal of the first switch, and a second terminal coupled to a respective phase terminal of the AC voltage supply, and
two leakage current circuits, each including a first terminal coupled to the second terminal of the first switch and a second terminal, wherein the second terminal of each of the two leakage current circuits is coupled to a different one of the two other phase terminals of the AC voltage supply,
wherein the processing circuitry controls current flow through the switching circuitry at least in part by providing gating signals to the two leakage current circuits of each of the first-phase, second-phase, and third-phase circuits based at least in part on voltage potentials between the phase terminals of the AC voltage supply and the phase terminals of the load and a mode of the switching circuitry.

2. The circuit breaker of claim 1, wherein, based on the mode of the switching circuitry corresponding to a standby mode, the processing circuitry transmits the gating signals to open each of the second switches and transmits the gating signals to close or open each of the leakage current circuits of each phase based on the respective voltage potentials to allow leakage current flow from respective phase terminals of the load to different phase terminals of the AC voltage supply through the respective leakage current circuits.

3. The circuit breaker of claim 1, wherein each of the two leakage current circuits of each phase circuit includes:
a capacitor including a first terminal coupled to the second terminal of the first switch, and a second terminal coupled to an anode terminal of a diode in series with the capacitor;
the diode including the anode terminal, and a cathode terminal coupled to a first terminal of a third switch in series with the diode; and
the third switch including the first terminal, and a second terminal coupled to the different one of the two other phase terminals of the AC voltage supply.

4. The circuit breaker of claim 1, wherein each of the two leakage current circuits of each phase circuit includes:
a first capacitor including a first terminal coupled to the second terminal of the first switch, and a second terminal coupled to an anode terminal of a silicon-controlled rectifier in series with the first capacitor; and
the silicon-controlled rectifier including the anode terminal, and a cathode terminal coupled to the different one of the two other phase terminals of the AC voltage supply.

5. The circuit breaker of claim 1, wherein:
each of the first switches comprises an electromechanical switch,
each of the second switches comprises a solid state switch, and
each of the switches of the two leakage current circuits comprises a solid state switch.

6. The circuit breaker of claim 1, wherein, based on the mode of the switching circuitry corresponding to an on mode, the processing circuitry transmits the gating signals to close each of the second switches and transmits the gating signals to open each of the leakage current circuits of each.

7. The circuit breaker of claim 1, wherein, based on the mode of the switching circuitry corresponding to an off mode, the processing circuitry transmits the gating signals to open each of the second switches and each of the leakage current circuits of each phase.

8. A method comprising:
monitoring voltage potentials in a circuit breaker, wherein the circuit breaker comprises:
switching circuitry coupled between an alternating current (AC) voltage supply and a load, wherein the switching circuitry includes three phase circuits, and wherein each of the phase circuits includes:
a disconnect switch;
a current-control switch; and
two leakage current circuits, wherein each of the two leakage current circuits is coupled between a load side of the current-control switch of a respective phase circuit and to a line side of the current-control switch of a different one of the phase circuits; and
for each of the phase circuits, responsive to determining a voltage potential between the load side of the current-control switch of the respective phase circuit and a line side of the current-control switch of at least one of the different ones of the phase circuits reaching a threshold voltage level, transmitting signals to one or more of the two leakage current circuits of the respective phase circuit, allowing leakage current flow from the load side of the current-control switch of the respective phase circuit to the line side of the current-control switch of the at least one of the different ones of the phase circuits.

9. The method of claim 8, further comprising:
prior to transmitting the signals to the one or more of the two leakage current circuits, transitioning the circuit breaker to a standby mode; and
responsively transmitting a signal to the current-control switch of each of the phase circuits to open the current-control switches.

10. The method of claim 8, wherein each of the two leakage current circuits comprises one or more solid-state switches.

11. The method of claim 8, wherein each of the disconnect switches comprises a mechanical switch, and wherein each of the current-control switches comprises a solid-state switch.

12. The method of claim 8, wherein each of the phase circuits corresponds to a different phase of three-phase AC power.

13. The method of claim 8, further comprising:
transitioning the circuit breaker to an on mode; and
responsively transmitting signals to the current-control switch of each of the phase circuits and to each of the leakage current circuits of each of the phase circuits to close the current-control switches and to open the leakage current circuits.

14. The method of claim 8, further comprising:
transitioning the circuit breaker to an off mode; and
responsively transmitting a signal to at least the disconnect switch of each phase circuit to open the disconnect switch.

15. One or more non-transitory computer-readable storage media having stored thereon program instructions executable by processing circuitry of a circuit breaker, that, when executed by one or more processors, direct the processing circuitry to:
monitor voltage potentials in the circuit breaker, wherein the circuit breaker comprises:
switching circuitry coupled between an alternating current (AC) voltage supply and a load, wherein the switching circuitry includes three phase circuits, and wherein each of the phase circuits includes:
a disconnect switch;
a current-control switch; and
two leakage current circuits, wherein each of the two leakage current circuits is coupled between a load side of the current-control switch of a respective phase circuit and to a line side of the current-control switch of a different one of the phase circuits; and
for each of the phase circuits, responsive to determining a voltage potential between the load side of the current-control switch of the respective phase circuit and a line side of the current-control switch of at least one of the different ones of the phase circuits reaching a threshold voltage level, transmit signals to one or more of the two leakage current circuits of the respective phase circuit, allowing leakage current flow from the load side of the current-control switch of the respective phase circuit to the line side of the current-control switch of the at least one of the different ones of the phase circuits.

16. The one or more non-transitory computer-readable media of claim 15, wherein the program instructions further direct the processing circuitry to:
prior to transmitting the signals to the one or more of the two leakage current circuits, transition the circuit breaker to a standby mode; and
responsively transmit a signal to the current-control switch of each of the phase circuits to open the current-control switches.

17. The one or more non-transitory computer-readable media of claim 15, wherein:
each of the two leakage current circuits comprises one or more solid-state switches;
each of the disconnect switches comprises a mechanical switch; and
each of the current-control switches comprises a solid-state switch.

18. The one or more non-transitory computer-readable media of claim 15, wherein each of the phase circuits corresponds to a different phase of three-phase AC power.

19. The one or more non-transitory computer-readable media of claim 15, wherein the program instructions further direct the processing circuitry to:
transition the circuit breaker to an on mode; and
responsively transmit signals to the current-control switch of each of the phase circuits and to each of the leakage current circuits of each of the phase circuits to close the current-control switches and to open the leakage current circuits.

20. The one or more non-transitory computer-readable media of claim 15, wherein the program instructions further direct the processing circuitry to:
transition the circuit breaker to an off mode; and
responsively transmit a signal to at least the disconnect switch of each phase circuit to open the disconnect switch.
